(19) United States
(12) Patent Application Publication
(10) Pub. No.: US 2017/0139217 A1
(43) Pub. Date: May 18, 2017

(54) MAGNIFYING BOTTLE CAP ASSEMBLY

(71) Applicant: Thomas Crenko, Bethlehem, PA (US)

(72) Inventor: Thomas Crenko, Bethlehem, PA (US)

(21) Appl. No.: 15/017,803

(22) Filed: Feb. 8, 2016

Related U.S. Application Data
(63) Continuation-in-part of application No. 14/944,346, filed on Nov. 18, 2015.

(51) Int. Cl. G02B 27/02; B65D 41/00; B65D 51/24; G02B 7/02

(52) U.S. Cl. CPC G02B 27/027; G02B 7/026; B65D 41/00; B65D 51/24

(57) ABSTRACT

A magnifying bottle cap assembly comprising a magnifying lens assembly. Said magnifying lens assembly comprising a magnifying lens with an integral radially extended periphery and a plurality of standoff reinforcing elements integral to said radially extended periphery, said standoff reinforcing elements arranged non-radially to the lateral plane of said radially extended periphery, a unitary cap body comprising an annular portion for engaging a bottle, said portion for engaging having an inner diameter less than or equal to the diameter of said magnifying lens assembly, a first annular retaining portion formed to mechanically engage the top of said magnifying lens assembly and to mechanically engage the perimeter of the standoff reinforcing elements integral to the top of said radially extended periphery, a second annular retaining portion formed to mechanically engage the bottom of said magnifying lens assembly and to mechanically engage the perimeter of the standoff reinforcing elements integral to the top of said radially extended periphery.

### RELATED U.S. APPLICATION

The present application is a continuation-in-part of U.S. application Ser. No. 14/944,346.

### FIELD OF THE INVENTION

The present invention relates generally to a magnification end cap and more particularly to a magnification end cap permitting a magnified view of the contents of a bottle and effecting stabilized, permanent engagement of the magnifying element of the magnification end cap with the body of the end cap.

### BACKGROUND

The use of a magnification device is known in the prior art for combination with jars, bottles and other containers, such as medicine bottles: for example U.S. Pat. No. 5,760,975 to DiGiovanni and U.S. application Ser. No. 10/807,411 by Muir; and specimen containers: for example Nature-Watch Bug Viewer and HABA Terra Kids Beaker Magnifier.

Prior art magnifying caps, or cap and bottle assemblies, have failed to integrate magnification means for viewing of the internal contents of the attached container with sealing properties sufficient to provide for stability of the container's contents and durability of the magnifying end cap itself. Relatedly, those containers in the prior art that do include magnifying means, such as U.S. Pat. No. 5,760,975 to DiGiovanni or U.S. Pat. No. 8,844,722 to Wang, fail to direct and apply the forces between the cap and container components to stabilize and secure the magnifying means within the cap to ensure security of the components of the container and cap, or the seal between the cap and container. This results in lack of reliability and durability of the magnifying cap itself and further prevents the designs of the prior art from achieving seals between the cap components or between the cap assembly and container portion sufficient to provide stable storage for the bottle's contents and protection of the contents from the deleterious effects of exposure to outside air, outside liquids, contaminants and the like.

While some prior art embodiments of magnifying lens caps and articles of manufacture including lens retention features employ friction to retain the placement of a lens into a cap, frame, barrel, or other body, additional prior art has recognized the benefit of retaining placement of the lens by other means. These means, however, do not effect permanent and stable engagement of the magnifying lens with the retaining element. For example, U.S. Pat. Nos. 6,899,427 and 7,524,054 to Sheldon suggest non-permanent methods of retaining the positioning of a lens in a frame. These references, however, still fail to effect permanent engagement of the lens with the frame and also fail to adequately reduce stress upon the lens from shear forces. U.S. Pat. No. 5,680,260 to Farcella, et al., and U.S. Pat. No. 7,289,282 to Matsushima similarly fail to achieve permanent engagement of the lens, and further, employ techniques that require the assembly of multiple pieces and risk breakage of the retaining members when the same are inserted into pre-defined recesses.

Therefore, a need remains for an improved magnifying bottle cap assembly that provides a magnified view of the contents of a bottle, coupled with improved, permanent engagement of the components thereof and stability and durability of the entire assembly.

### BRIEF SUMMARY OF THE INVENTION

The present invention is a magnifying bottle cap assembly with improved stability of its component elements including a cap body, an integrated magnifying lens element, said lens element further comprising a lens with a radially extended periphery and standoff reinforcing elements arranged in a non-radial position thereto. The cap body is formed to further comprise top and bottom annular retaining rings for contacting and permanently retaining the radially extended periphery of the lens element and to full engage the circumference and at least partially engage the height of the standoff reinforcing elements. The magnifying cap assembly, when engaged with a container, effectuates a seal between the cap assembly and container thereby permitting secure storage of contents, such as medicines, biology samples, specimens and the like, within the container. The magnifying bottle cap assembly provides magnification of the contents of the container, as well as other benefits including stable storage of the contents of the container and the prevention of the entrance of air or liquid into the sealed container and the effects of the interaction of such fluids with the contents of the assembly.

Magnifying bottle assemblies with improved stability and permanence of an integrated magnifying element consistent with the teachings of the present disclosure, as described above and as further described herein, permit the stable storage of the contents of the bottle and cap assembly and permit one to view the contents of the bottle and cap assembly optically magnified.

Embodiments of the present invention, as described further herein, may further include child safety mechanisms and/or a separable lens cover.

### BRIEF DESCRIPTION OF THE DRAWINGS

FIG. 1 is a bottom perspective view of a magnifying bottle cap assembly in accordance with the present invention.

FIG. 2 is a perspective view of a magnifying lens element.

FIG. 3 is a cross-sectional view of a magnifying bottle cap assembly in accordance with the present invention.

FIG. 4 is a top perspective view of a magnifying bottle cap assembly in accordance with the present invention.

FIG. 5 is an exploded view of one embodiment of a magnifying bottle cap assembly in accordance with the present invention and a bottle to which such cap assembly may be engaged.

FIGS. 6a and 6b are perspective views of magnifying bottle cap assemblies in accordance with the present invention and a bottle to which such cap assembly may be engaged.

### DETAILED DESCRIPTION OF THE INVENTION

The invention of the present disclosure is described below with reference to certain embodiments. While these embodiments are set forth in order to provide a thorough and enabling description of the invention, these embodiments are not set forth with the intent to limit the scope of the disclosure. A person of skill in the art will understand that the invention may be practiced in numerous embodiments, of which those detailed here are merely examples. In order to allow for clarity of the disclosure of the claimed invention, structures and functions well known to those skilled in the art are not here disclosed. Those skilled in the art should also realize that equivalent magnifying bottle cap assemblies do not depart from the spirit and scope of the invention in its broadest form.

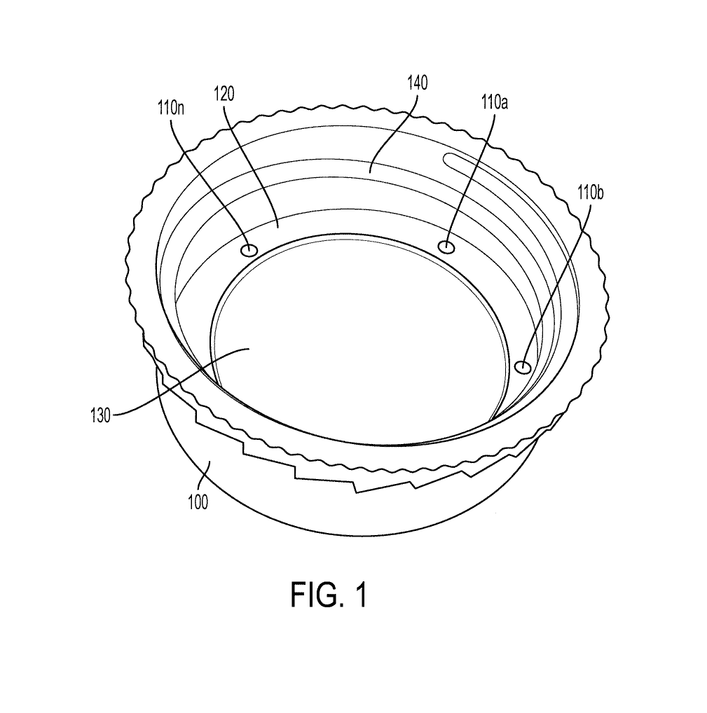

FIG. 1 depicts an exemplary embodiment of a magnifying bottle cap assembly according to the present invention, comprising a bottle cap body 100 formed to stably and permanently engage a magnifying lens element 130. A cap body 100 such as the one shown may be formed by, for example, injection molding. The process of injection molding the cap body 100 causes the formation of a bottom retaining ring 120 that engages at least a portion of the bottom of an extended periphery of the magnifying lens element 130. The bottom retaining ring 120 is formed to be in contact with the circumference of each of a plurality of standoff reinforcing rods 110a-n, effecting the aforementioned stability and permanent engagement. The embodiment shown includes thread elements 140 for engaging the magnifying bottle cap assembly to a storage container, such as a medicine bottle.

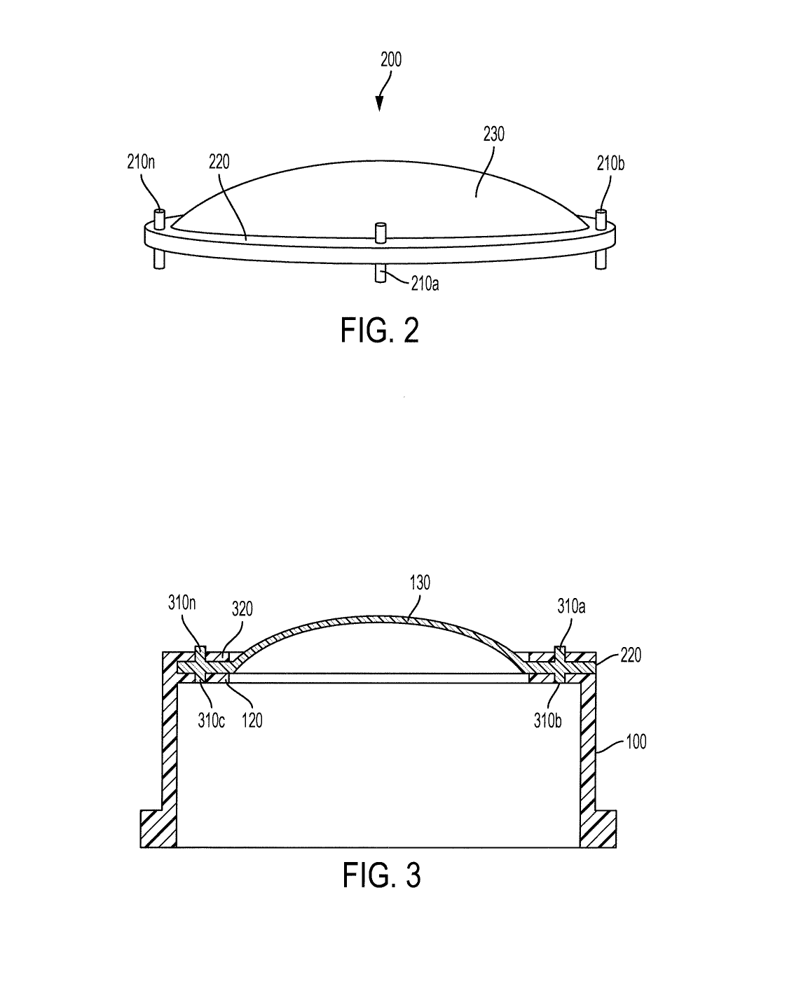

The previously described magnifying lens element of the magnifying bottle cap assembly is further illustrated by FIG. 2, a perspective view of the magnifying lens element 200 in isolation. In the embodiment shown, the magnifying lens element 200 is a unitary element comprising a lens 230 formed with an extended periphery 220. Disposed upon the extended periphery 220 is a plurality of standoff reinforcing rods 210a-n for improvement of the engagement of the magnifying lens element 200 with a cap body. In the embodiment shown, the standoffs 210a-n are perpendicular to the radial plane of the magnifying lens element. It will be noted that these standoffs may be non-normal to the radial plane without departing from the teaching of the present disclosure. That is, the angle between the standoffs 210a-n and the extended periphery 220 need not be ninety degrees. As used herein, the terms axial and non-radial shall refer to the placement of any element in a position not parallel to or co-planar with the radially extended periphery 220.

The mechanical engagement of the magnifying lens element to the top and bottom annular retaining rings is described herein with reference to standoff reinforcing rods. It will, however, be understood that other geometric formations of the standoff reinforcing elements are consistent with the present invention and the word rod shall not limit the present invention to the use of cylindrical standoff reinforcing elements. For example, and without limitation, the standoff reinforcing elements may be simple geometric shapes, such as square or rectangular solids, but may also be formed in any manner of standoff such that the perimeter or circumference of the standoff may be mechanically engaged by the formation of the annular retaining rings. As such, one may also practice the present invention by employing a combination of different geometric shapes for the standoffs in the same embodiment.

While FIG. 2 depicts the standoff reinforcing rods 210a-n on both the top and bottom of the extended periphery 220, some embodiments of the present invention may include standoff reinforcing rods on the top, or bottom, or both, of the extended periphery. Further, in the embodiments employing standoff reinforcing rods on both top and bottom of the extended periphery, it is not required that the number of reinforcing rods on top and bottom be equal, or that the standoff reinforcing rods on the top align with those on the bottom. However, some embodiments may employ such alignment of the standoff reinforcing rods to control the amount of light transmitted from the exterior of the cap, and the container to which it is applied, to the inside of the container. This may be desirable where, for instance, more light transmission is desired in order to observe specimens within the container, or where less light transmission is desired to avoid its potentially deleterious effect upon the contents of the container. One may also select the material, color or other properties of the magnifying lens element and standoff reinforcing rods to increase or reduce this transmission of light.

FIG. 3 shows a cross-sectional view of the magnifying lens element, previously described, having been permanently engaged in a cap body 100 by encapsulating the extended periphery 220 of the magnifying lens element between formed top 320 and bottom 120 annular retaining rings of the cap body. The top 320 and bottom 120 annular retaining rings are unitary to the cap body 100, which unitary structure may be formed by processes known to those of skill in the art. Such processes may include, but are not limited to, insert molding the cap body by placing the previously manufactured magnifying lens element into an injection mold for formation of the cap body, or by the process of overmolding the lens element and cap body in first and second shots, respectively. Other methods of injection molding, compression molding, additive manufacturing, or the like, in addition to numerous other methods may be employed as determined by a person of skill in the art.

The encapsulation of at least a portion of the extended periphery 220 is accomplished by the definition of a retaining channel comprising the top annular retaining ring 320, the bottom annular retaining ring 120 and the wall of the cap body 100. Since this retaining channel is formed after the manufacture of the lens element—even in such processes as overmolding—the retaining channel fully encircles the perimeter of the extended periphery 220, providing permanent hold upon the lens element. The annular retaining rings comprising the channel are of a radius that permits the lens portion 130 of the lens element to remain at least partially unobstructed to permit the use of the lens for its stated purpose of magnifying viewable items.

The formation of the cap body 100 and process of encapsulating the periphery of the magnifying lens element cause the top and bottom annular retaining ring elements 320, 120, of the cap body to fully encapsulate the circumference of each of a plurality of standoff reinforcing rods 310a-n. The depth of each retaining ring portion is sufficient to contact and stabilize the magnifying lens element and to encapsulate some height of each standoff reinforcing rod, though it is not necessary that the depth of the annular retaining ring elements reach the full height of the standoff reinforcing rods. This process thereby forms an aperture around each of the standoffs, within the radius of the annular retaining ring. This causes the standoff reinforcing rods to provide various benefits to the combined cap body and magnifying lens assembly, including stability and added permanence of the placement of the lens and retention of the lens element position in the event of the application of shear force or impact to the combined assembly. Additionally, the mechanical bond between the standoff reinforcing rods and the annular retaining rings, in combination with the formation of the top and bottom retaining rings to form the retaining channel in direct contact with the top and bottom surfaces of the extended periphery of the magnifying lens element permit effective sealing properties of the magnifying cap assembly without the need for adhesives or bonding agents between the cap body and magnifying lens element. This provides beneficial storage properties to the assembly and reduces cost and labor in manufacture.

In an alternative embodiment, the bottom and top annular retaining rings 120, 320, and thereby the retaining channel defined by them, may be formed in a non-continuous manner, so that, in conjunction with an also non-continuous extended periphery 220, openings in the magnifying cap assembly may be created. In such arrangements, placement of the discontinuities in the extended periphery 220 and the annular retaining rings 120, 320 may be designed to coincide with the placement of the standoff reinforcing rods 310a-n so that the stability, reinforcement and permanent engagement benefits of the reinforcing rods and the bond between them and the cap body 100 may be maintained.

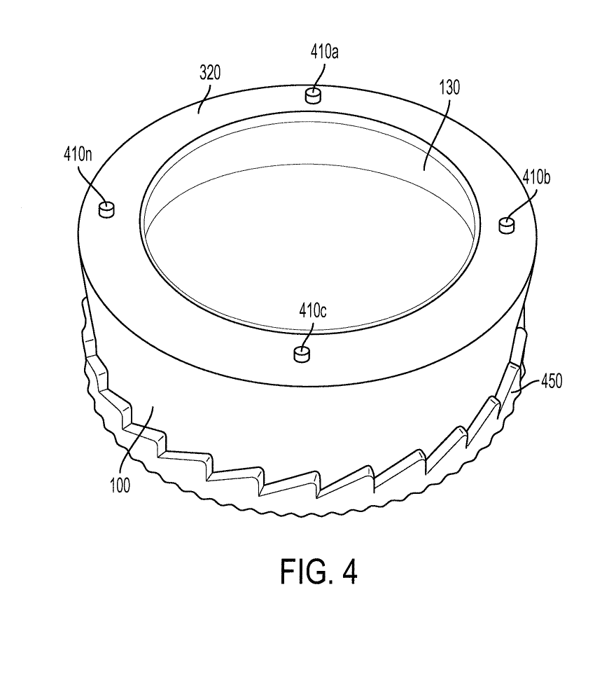

Turning now to FIG. 4, it is shown that the present invention may be embodied in an inner cap assembly wherein the cap body 100 may include extruded engaging teeth 450 on its outer circumference, thereby permitting the magnifying cap assembly to be coupled with an outer cap having complementary teeth. This permits employment of the magnifying and other beneficial uses of cap according to the disclosed invention in conjunction with “child resistant” or similar safety properties. In addition to this “push and turn” style arrangement, as shown, the cap body may also be formed to implement “squeeze and turn,” tab alignment, lug and seat, or other safety measures now or hereafter known.

Also shown in FIG. 4, the height of the standoff retaining rods 410a-n need not be equal to the height of the annular retaining ring contacting those standoff retaining rods. However, it is also contemplated that, in the event the cap body 100 is manufactured so that the height of the annular retaining ring does not cause it to fully enclose the height of the standoff retaining rods, the standoff retaining rods may also be trimmed in a later manufacturing step to be flush with the top surface of the cap body formed by the top annular retaining ring.

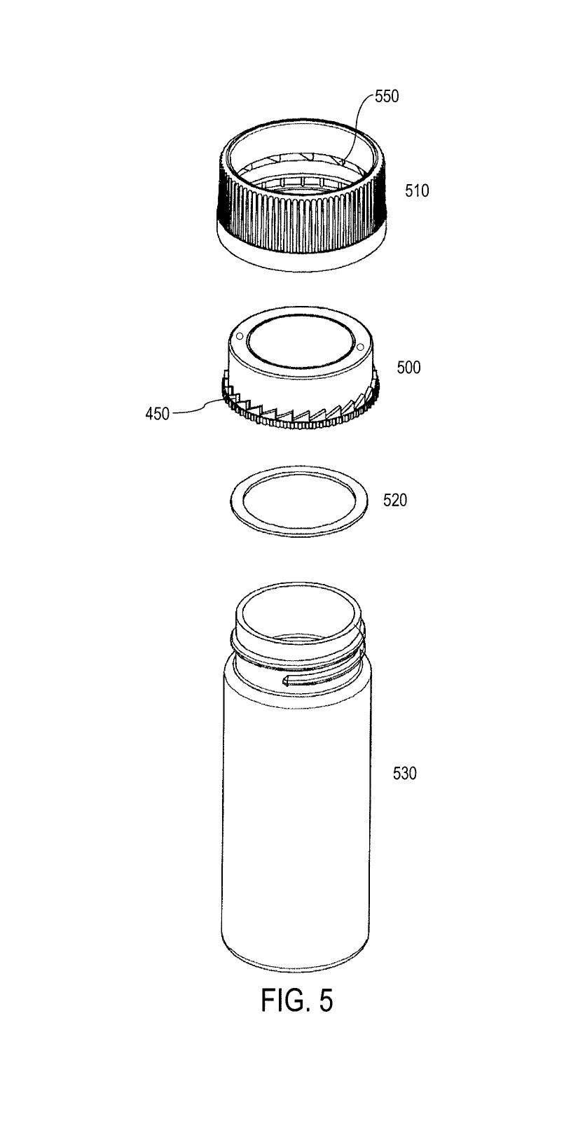

FIG. 5 further illustrates the use of a magnifying cap assembly according to the present disclosure in the context of a child-resistant assembly. As shown, the magnifying lens assembly 500 is formed as an inner cap, having extruded engaging teeth 450 upon its outer circumference. An outer cap 510 includes complementary engaging teeth 550. When the outer cap 510 is engaged to the cap body 500, the two elements may snap together in order to be applied, optionally in conjunction with a gasket 520, to a container 530, but turning the outer cap 510 will not cause the cap body 500 to turn until downward force is applied, causing the complementary teeth 550 of the outer cap to engage the extruded engaging teeth 450.

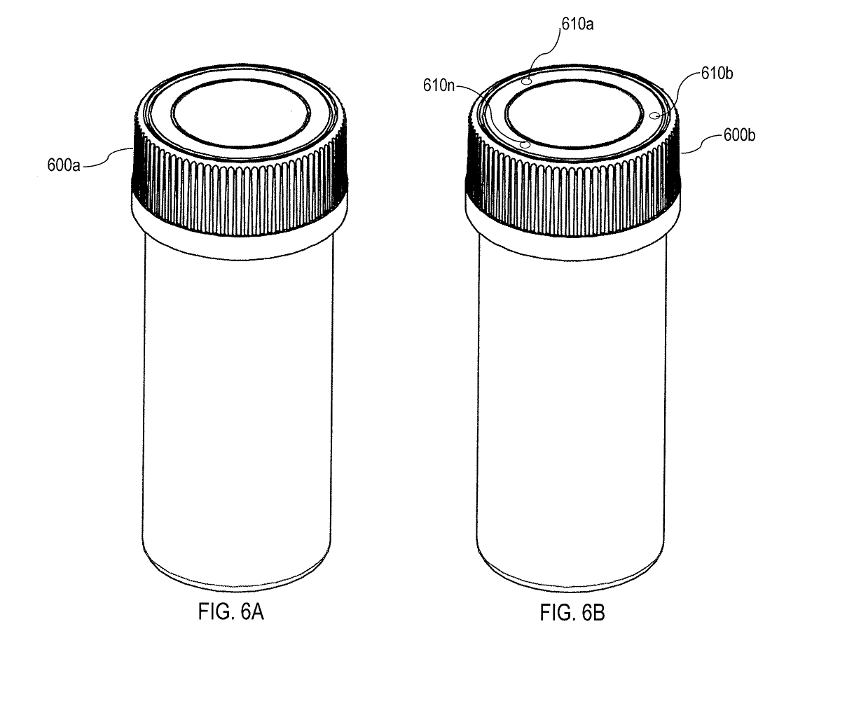

FIGS. 6a and 6b shall clearly illustrate that the present invention does not require the use of child-resistant components. As shown, both the magnifying cap assemblies of 600a and 600b are simple screw-top implementations of the present disclosure. FIGS. 6a and 6b further illustrate the aforementioned ability to manufacture embodiments of the present invention in the form of a magnifying cap assembly 600a that does not include standoff retaining rods disposed upon the top portion of the magnifying lens element, wherein such standoff retaining rods will be present on the bottom of the magnifying lens element, as well as a magnifying cap assembly 600b wherein standoff retaining rods are disposed upon the top portion of the magnifying lens element, wherein standoff retaining rods may also, but need not, be disposed upon the bottom of the magnifying lens element.

Alternative embodiments of the present invention may also include a lens cover element for protection of the lens and for reduction of light transmission through the lens while the lens cover is engaged. In one embodiment, the cap body includes a raised annular portion substantially concentric to lens. The inner circumference of the lens cover may then engage this raised annular portion to “snap” into place. Such lens cover may be formed as being integral to the cap body, for instance by forming the cap body, the lens cover and a hinge element connecting them as a unitary piece. The present disclosure also contemplates that the lens cover may be fully separable from the cap body. In either embodiment, the lens cover and the cap body may further include a latch element, such as extruded tabs on each element, meant to engage one another and retain the lens cover's engagement to the cap body.

While various disclosed embodiments have been described above, it should be understood that they have been presented by way of example only, and not limitation. Numerous changes to the subject matter disclosed herein can be made in accordance with this disclosure without departing from the spirit or scope of this disclosure. In addition, while a particular feature may have been disclosed with respect to only one of several implementations, such feature may be combined with one or more other features of the other implementations as may be desired and advantageous for any given or particular application.

What is claimed is:

1. A magnifying bottle cap assembly comprising:
a. a magnifying lens assembly said magnifying lens assembly comprising a magnifying lens with an integral radially extended periphery and a plurality of standoff reinforcing elements integral to said radially extended periphery
b. said standoff reinforcing elements arranged non-radially to the lateral plane of said radially extended periphery
c. a unitary cap body comprising
i. an annular portion for engaging a bottle
ii. said portion for engaging having an inner diameter less than or equal to the diameter of said magnifying lens assembly
iii. a first annular retaining portion formed to mechanically engage the top of said magnifying lens assembly and to mechanically engage the standoff reinforcing elements integral to the top of said radially extended periphery
iv. a second annular retaining portion formed to mechanically engage the bottom of said magnifying lens assembly and to mechanically engage the standoff reinforcing elements integral to the top of said radially extended periphery.

2. The magnifying bottle cap assembly of claim 1 wherein said portion for engaging further comprises thread members.

3. The magnifying bottle cap assembly of claim 1 wherein said portion for engaging further comprises a plurality of child-safe lugs for engaging a plurality of child-safe seats on said bottle.

4. The magnifying bottle cap assembly of claim 1 further comprising a first plurality of extruded engaging teeth disposed on its outer circumference and an outer cap body having a second plurality of extruded engaging teeth disposed on the inner circumference of said outer cap body said first and second plurality of extruded engaging teeth arranged to permit said portion for engaging to be disengaged from a bottle only when said first and second plurality of extruded engaging teeth are mechanically engaged with each other by the application of downward force upon said outer cap body.

5. The magnifying bottle cap assembly of claim 1 further comprising a lens cover.

6. A method for manufacturing a magnifying bottle cap assembly comprising the steps of:
a. Providing a magnifying lens assembly said magnifying lens assembly comprising a magnifying lens with a radially extended periphery and a plurality of standoff reinforcing elements integral to said radially extended periphery said standoff reinforcing elements arranged non-radially to the lateral plane of said radially extended periphery;
b. inserting into a molding device said magnifying lens assembly;
c. forming in said molding device by the introduction of molding material into said molding device
i. a unitary cap body suitable for engaging a bottle, said cap body comprising:
ii. a first annular retaining portion for mechanically engaging the top of said magnifying lens assembly and mechanically engaging the standoff reinforcing elements integral to the top of said radially extended periphery
iii. a second annular retaining portion for mechanically engaging the bottom of said magnifying lens assembly and mechanically engaging the standoff reinforcing elements integral to the bottom of said radially extended periphery
d. said forming step further comprising permitting said molding material to cure.

7. The method of claim 6 wherein said forming step further comprises reducing the length of each of said plurality of standoff reinforcing elements mechanically engaged with said first annular retaining portion to be substantially equal to the thickness of said first annular retaining portion.

8. The method of claim 6 wherein said forming step further comprises reducing the length of each of said plurality of standoff reinforcing elements mechanically engaged with said second annular retaining portion to be substantially equal to the thickness of said second annular retaining portion.

9. The method of claim 6 wherein said forming step is by injection molding.

10. The method of claim 6 wherein said forming step is by compression molding.

11. The method of claim 6 wherein said forming step is by casting.
